(19) United States
(12) Patent Application Publication
(10) Pub. No.: US 2020/0365955 A1
(43) Pub. Date: Nov. 19, 2020

(54) VEHICLE BATTERY COOLING SYSTEM

(71) Applicants: Hyundai Motor Company, Seoul (KR); Kia Motors Corporation, Seoul (KR)

(72) Inventor: Min Wook KIM, Yongin-si (KR)

(73) Assignees: Hyundai Motor Company, Seoul (KR); Kia Motors Corporation, Seoul (KR)

(21) Appl. No.: 16/588,474

(22) Filed: Sep. 30, 2019

(30) Foreign Application Priority Data
May 16, 2019 (KR) 10-2019-0057529

(51) Int. Cl. H01M 10/625; H01M 10/6556; H01M 2/04

(52) U.S. Cl. CPC H01M 10/625; H01M 2/043; H01M 10/6556

(57) ABSTRACT

A vehicle battery cooling system may include a first battery module, a second battery module disposed above the first battery module, a first cover disposed between the first battery module and the second battery module, covering the first battery module, and having the second battery module disposed thereon, a second cover of covering the second battery module, and a third cover disposed above the second cover and covering the second cover, wherein the second cover or the third cover includes a cooling flow channel in which a coolant flows, and the coolant flows into the cooling channel path to cool the second battery module.

### CROSS REFERENCE TO RELATED APPLICATION

The present application claims priority to Korean Patent Application No. 10-2019-0057529, filed on May 16, 2019, the entire contents of which is incorporated herein for all purposes by this reference.

### BACKGROUND OF THE INVENTION

### Field of the Invention

The present invention relates to a vehicle battery cooling system, and more particularly, to a vehicle battery cooling system for protecting a battery module from coolant leakage by forming a cooling unit of cooling a second layer battery module, outside a battery cover in a battery system including battery modules configured with two layers.

### Description of Related Art

Due to the popularization of an electric vehicle or a hybrid vehicle, batteries have become important day by day. Such interests have been extensively applied to factors that affect the efficiency, lifetime, and the like of batteries, as well as to capacitance of batteries.

A high-voltage and high-capacitance battery used in an electric vehicle or a hybrid vehicle generally includes a battery pack formed by configuring a plurality of battery cells as one pack, and the battery pack is also configured in a plural number to configure an entire battery.

Such a plurality of battery packs are disposed together in a limited narrow space, and thus, high-temperature heat is generated from the battery packs, which functions as a factor that adversely affects the total lifetime of a battery. Accordingly, it is required to establish a cooling system for controlling high-temperature heat of a high-voltage and high-capacitance battery used in an electric vehicle or a hybrid vehicle, and in general, a high-voltage and high-capacitance battery cooling method for a vehicle is classified into air cooling and water cooling, each of which is classified into an indirect cooling method and a direct cooling method.

FIG. 1 is a diagram showing a conventional cooling system for cooling battery modules at upper and lower layers in a battery system including the battery modules configured as two layers. As shown in FIG. 1, conventionally, a cooling channel 30 for cooling a battery module disposed at a second layer is formed between a second layer battery module 20 and a first layer battery module 10, which are disposed in a battery case 40. Thus, when a coolant leaks from the cooling channel for the second layer battery module, the coolant is scattered to the first layer battery module to cause a safety problem. Furthermore, the first layer battery module is disposed between a cooling channel below the first layer battery module and a cooling channel above the first layer battery module, and thus, there is a problem in that the battery module is excessively cooled to hinder uniform cooling of the entire battery module. Accordingly, there has been a need to develop technologies for a battery cooling system for protecting a battery module even if a coolant leaks while uniformly cooling an entire battery module.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle battery cooling system for protecting a battery module even if a coolant leaks and for uniformly cooling the entire battery module.

According to an exemplary embodiment of the present invention, a vehicle battery cooling system may include a first battery module, a second battery module disposed above the first battery module, a first cover disposed between the first battery module and the second battery module, covering the first battery module, and having the second battery module disposed thereon, a second cover of covering the second battery module, and a third cover disposed above the second cover and covering the second cover, wherein the second cover or the third cover may include a cooling flow channel in which a coolant flows, and the coolant flows into the cooling channel path to cool the second battery module.

The second cover may have a side surface portion, an upper surface portion, and an open bottom surface, to form an accommodation space therein for accommodating the second battery module.

The upper surface portion of the second cover may be formed of an aluminum material, the side surface portion may be formed of a steel material, and a cooling flow channel in which a coolant flows is formed in an upper surface of the upper surface portion.

The second cover may further include an extension portion that extends from an edge portion of the open bottom surface to overlap the first cover.

The extension portion of the second cover may be coupled to an upper portion of the first cover via friction stir welding (FSW) or metal inert gas welding (MIG).

An open hole may be formed at a position of the first cover, at which the second battery module is disposed.

The first cover may further include a sidewall portion that extends upward along an edge portion of the open hole.

The vehicle battery cooling system may further include a sealing unit disposed between the sidewall portion and the second cover.

The sidewall portion, the second cover, the sealing unit, and the third cover may be coupled via bolding coupling.

The second cover may be formed in a panel shape and is formed of an aluminum material.

A cooling flow channel in which a coolant flows may be formed in a bottom surface of the third cover and may be formed to cover the upper surface of the second cover.

The vehicle battery cooling system may further include a battery module cooling unit which is formed below the first battery module, may include a cooling flow channel in which a coolant flows, and cools the first battery module by allowing the coolant to flow in the cooling flow channel.

The vehicle battery cooling system may further include a coolant injection pipe which is formed outside the first cover and the second cover and injects a coolant into the cooling flow channel formed in the first battery module cooling unit, the second cover, or the third cover, and a coolant discharge pipe from which a coolant circulating in the cooling flow channel formed in the first battery module cooling unit, the second cover, or the third cover is discharged.

The coolant injection pipe and the coolant discharge pipe may be formed in a side surface of an external side of each of the first cover and the second cover.

The vehicle battery cooling system may further include a coolant dividing unit which is connected to the coolant injection pipe and divides and injects a coolant into the cooling flow channel formed in the first battery module cooling unit, the second cover, or the third cover.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram showing a conventional battery cooling system including battery module configured with two layers.

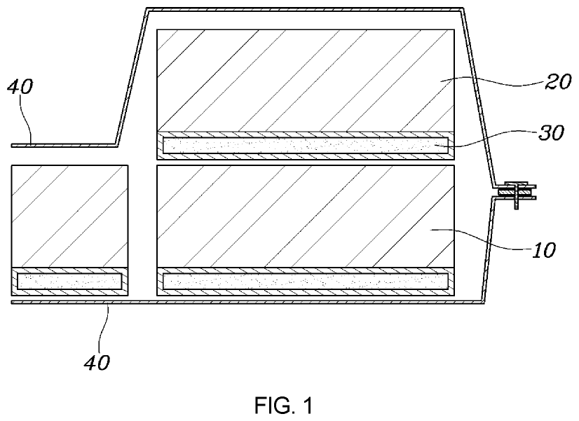

FIG. 2 is a perspective view of a vehicle battery cooling system according to an exemplary embodiment of the present invention.

FIG. 3 is an exploded perspective view of a vehicle battery cooling system according to an exemplary embodiment of the present invention.

FIG. 4 is a cross-sectional view taken along A-A′ of FIG. 3.

FIG. 5 is an exploded perspective view of a vehicle battery cooling system according to various exemplary embodiments of the present invention.

FIG. 6 is a cross-sectional view taken along B-B′ of FIG. 5.

FIG. 7 is a diagram showing a coolant injection pipe formed outside a first cover and a second cover and configured to inject a coolant into a first cooling unit.

FIG. 8 is a diagram showing a coolant dividing unit of dividing a coolant and injecting the divided coolant into the first cooling unit and the second cooling unit.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a vehicle battery cooling system according to exemplary embodiments of the present invention is described with reference to the accompanying drawings.

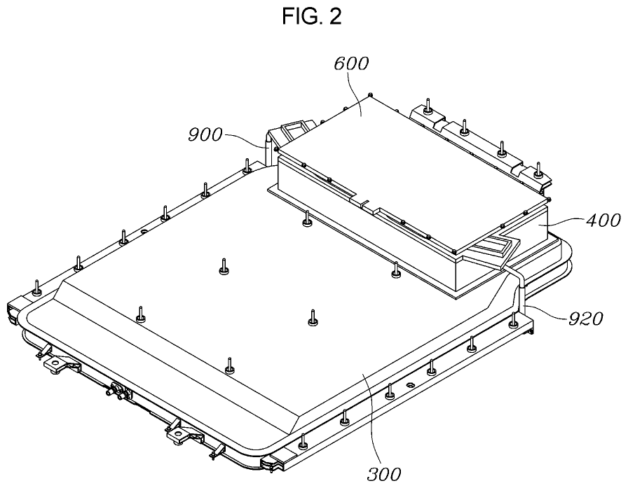

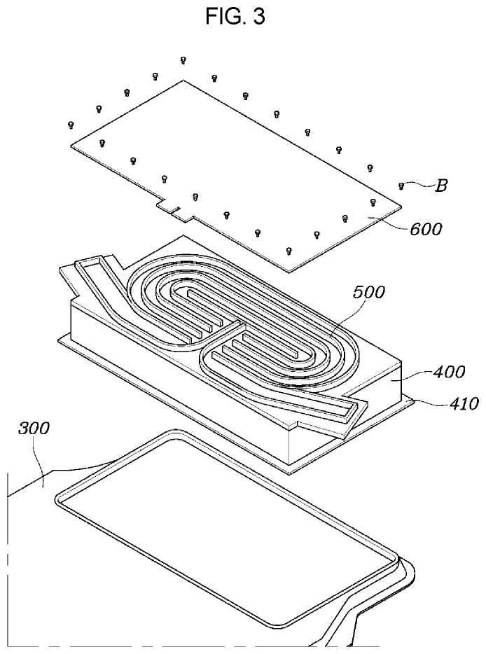

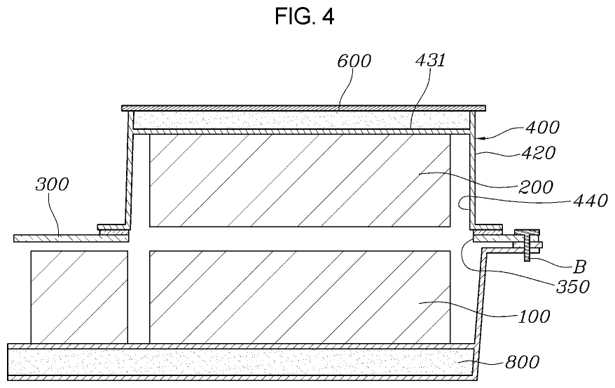

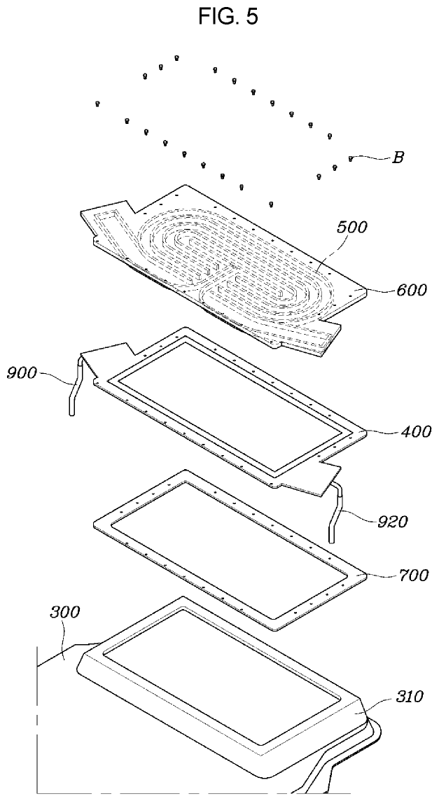

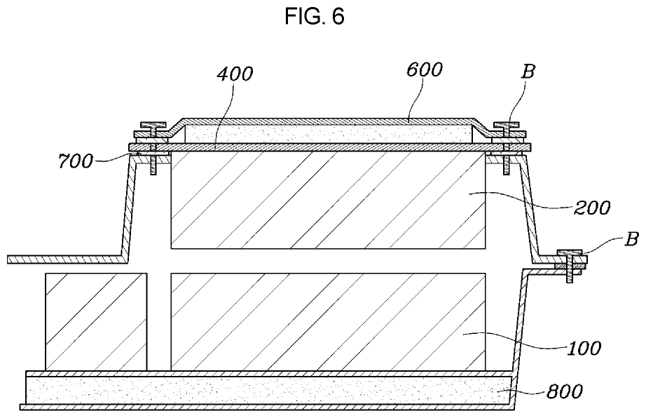

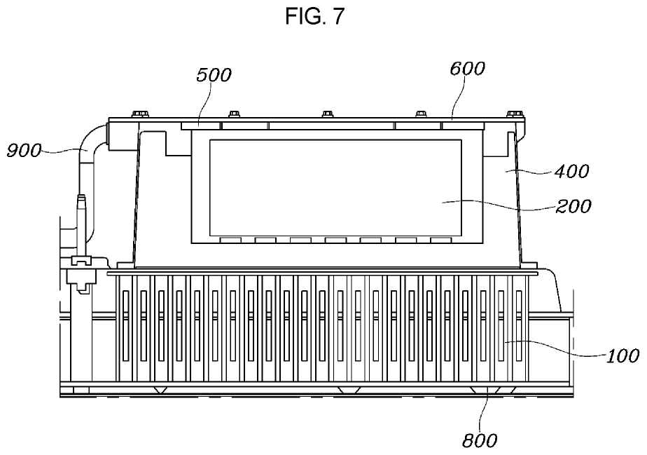

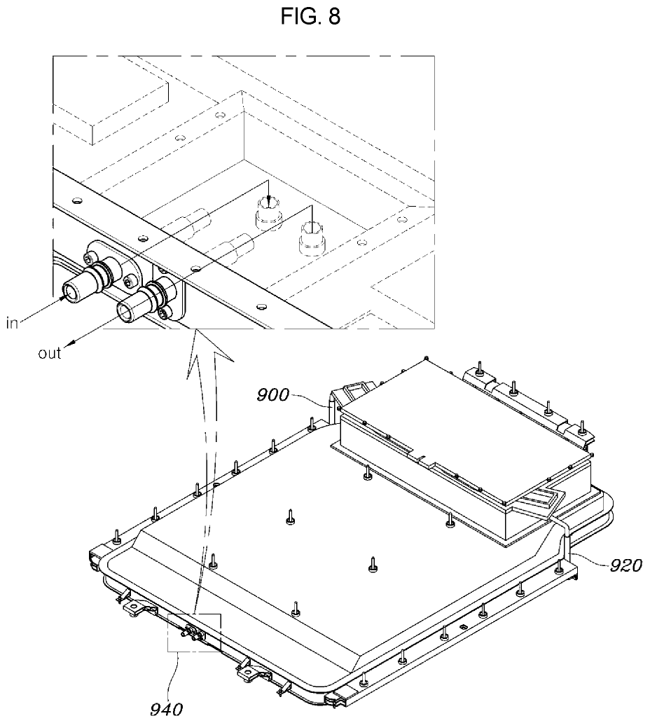

FIG. 2 is a perspective view of a vehicle battery cooling system according to an exemplary embodiment of the present invention. FIG. 3 is an exploded perspective view of a vehicle battery cooling system according to an exemplary embodiment of the present invention. FIG. 4 is a cross-sectional view taken along A-A′ of FIG. 3. FIG. 5 is an exploded perspective view of a vehicle battery cooling system according to various exemplary embodiments of the present invention. FIG. 6 is a cross-sectional view taken along B-B′ of FIG. 5. FIG. 7 is a diagram showing a coolant injection pipe formed outside a first cover and a second cover and configured to inject a coolant into a first cooling unit. FIG. 8 is a diagram showing a coolant dividing unit of dividing a coolant and injecting the divided coolant into the first cooling unit and the second cooling unit.

As shown in FIGS. 2 to 6, a vehicle battery cooling system according to an exemplary embodiment of the present invention may include a first battery module 100, a second battery module 200, a first cover 300, a second cover 400, and a third cover 600, and may further include a sealing unit 700, a battery module cooling unit 800, a coolant injection pipe 900, a coolant discharge pipe 920, and a coolant dividing unit 940. Hereinafter, the detailed configuration of a vehicle battery cooling system according to an exemplary embodiment of the present invention will be described in more detail.

The first battery module 100 may be a battery module which is disposed at a first layer of a battery system including two layers and may include a plurality of battery cells. Furthermore, the second battery module 200 may be a battery module disposed above the first battery module 100 and may be a battery module disposed at a second layer in the battery system including two layers. Like the first battery module 100, the second battery module 200 may also include a plurality of battery cells.

The first cover 300 may be disposed between the first battery module 100 and the second battery module 200. Furthermore, a structure for supporting the second battery module 200 disposed above the first battery module 100 may be disposed between the first battery module 100 and the second battery module 200, and according to an exemplary embodiment of the present invention, the first cover 300 may function as the structure for supporting the second battery module 200.

The first cover 300 may cover the first battery module 100 and may prevent impurities, etc. from penetrating into the first battery module 100 from the outside. Furthermore, the second battery module 200 may be disposed above the first cover 300. In the instant case, an open hole 350 may be formed at a position of the first cover 300, at which the second battery module 200 is disposed, and in various exemplary embodiments of the present invention, the open hole may have a shape corresponding to the second battery module 200. In various exemplary embodiments of the present invention, the first cover 300 may be an aluminum plate-shaped press or a steel press formed of an aluminum material or a steel material.

The second cover 400 may cover the second battery module 200 and may prevent impurities, etc. from penetrating into the second battery module 200 from the outside. The third cover 600 may be mounted above the second cover 400 and may cover the second cover 400. As shown in FIG. 3 and FIG. 4, the third cover 600 may be coupled to the second cover 400 via welding or bolting coupling. In more detail, an edge portion of the third cover 600 may be coupled to an edge portion of the second cover 400 via welding or bolting coupling along the edge portion of the second cover 400.

A first cooling flow channel 500 in which a coolant flows may be formed in the second cover 400 or the third cover 600, and a coolant may flow in the corresponding first cooling flow channel 500 to cool the second battery module 200.

In detail, as shown in FIG. 3 and FIG. 4, in the vehicle battery cooling system according to an exemplary embodiment of the present invention, the second cover 400 may have a side surface portion 420, an upper surface portion 430, and an open bottom surface 440 to form an accommodation space therein for accommodating the second battery module 200. In various exemplary embodiments of the present invention, the upper surface portion of the second cover 400 may be formed of an aluminum material with excellent thermal conductivity and the side surface portion may be formed of a steel material. In the instant case, the first cooling flow channel 500 in which a coolant flows may be formed on an upper surface portion of the second cover 400, and as a coolant flows into the corresponding cooling flow channel 500, the second battery module 200 may be cooled.

Accordingly, according to an exemplary embodiment of the present invention, the first cooling flow channel 500 for cooling the second battery module 200 may be formed on an upper surface of the upper surface portion of the second cover 400 for covering the second battery module 200 and may cover the second cover 400 through the third cover 600 to seal the cooling flow channel 500, and thus even if a coolant leaks from the cooling flow channel 500, the coolant may be prevented from being scattered to the battery module to prevent the corresponding battery module from being damaged.

Conventionally, a cooling device configured for cooling the second battery module 200 is formed above the first battery module 100, and thus cooling units are formed above and below the first battery module 100 to excessively cool the first battery module 100 and to hinder uniform cooling of the entire battery module. On the other hand, unlike in the conventional case, according to an exemplary embodiment of the present invention, the first cooling flow channel 500 for cooling the second battery module 200 may be formed on the upper surface of the second cover 400 for covering the second battery module 200, and thus it may be possible to uniformly cool the first battery module 100 and the second battery module 200.

The second cover 400 may further include an extension portion 410 that extends from an edge portion of the open bottom surface to overlap the first cover 100. The extension portion 410 formed on the bottom surface of the second cover 400 may have an area for overlapping with a portion of an edge portion of the open hole formed in the first cover 300 when the second battery module 200 is covered by the second cover 400, and may be coupled to the first cover 300 via welding along the edge portion of the open hole formed in the first cover 300. In the instant case, in various exemplary embodiments of the present invention, the extension portion 410 of the second cover 400 may be coupled to the first cover 300 via friction stir welding (FSW) or metal inert gas welding (MIG) along the edge portion of the open hole formed above the first cover 300.

In the vehicle battery cooling system according to various exemplary embodiments of the present invention, as shown in FIG. 5 and FIG. 6, the first cover 300 may further include a sidewall portion 310 that extends upward along the edge portion of the open hole. In the instant case, the first cover 300 and the sidewall portion 310 may be formed of a steel material. Furthermore, the first cover 300 may further include the sealing unit 700 that functions as sealing between the sidewall portion 310 and the second cover 400. Here, the sealing unit 700 may be a rubber sealing gasket formed of a rubber material. Furthermore, the sidewall portion 310, the second cover 400, the sealing unit 700, and the third cover 600 may be coupled via bolting coupling.

Referring to FIG. 5, in the vehicle battery cooling system according to various exemplary embodiments of the present invention, the second cover 400 may be formed in a panel shape and may be formed of an aluminum material. In the instant case, the first cooling flow channel 500 in which a coolant flows may be formed in a bottom surface of the third cover 600 which is disposed above the second cover 400 and covers the second cover 400, and the corresponding first cooling flow channel 500 may be formed to contact with the upper surface of the second cover 400, and thus as a coolant flows into the cooling flow channel 500, the second battery module 200 disposed below the second cover 400 may be cooled.

In other words, in the vehicle battery cooling system according to various exemplary embodiments of the present invention, as shown in FIG. 5 and FIG. 6, the first cooling flow channel 500 for cooling the second battery module 200 may be formed on the bottom surface of the third cover 600 for covering the second cover 400 disposed above the second battery module 200, and the first cooling flow channel 500 may be sealed through the second cover 400 and the third cover 600, and thus even if a coolant leaks from the cooling flow channel 500, the coolant may be prevented from being scattered to the battery module to prevent the corresponding battery module from being damaged. Conventionally, a cooling device configured for cooling the second battery module 200 is formed above the first battery module 100, and thus cooling units are formed above and below the first battery module 100 to excessively cool the first battery module 100 and to hinder uniform cooling of the entire battery module. On the other hand, unlike in the conventional case, according to an exemplary embodiment of the present invention, the first cooling flow channel 500 for cooling the second battery module 200 may be formed on the bottom surface of the third cover 600 disposed above the second cover 400 for covering the second battery module 200, and thus it may be possible to uniformly cool the first battery module 100 and the second battery module 200.

The vehicle battery cooling system according to an exemplary embodiment of the present invention may further include the battery module cooling unit 800 which is formed below the first battery module 100, includes an insertion groove for inserting the first battery module 100 thereinto and a cooling flow channel in which a coolant flows, and cools the first battery module 100 by allowing the coolant to flow in the cooling flow channel.

Furthermore, the vehicle battery cooling system according to an exemplary embodiment of the present invention may further include the coolant injection pipe 900 which is formed outside the first cover 300 and the second cover 400 and injects a coolant into the second cooling flow channel formed in the battery module cooling unit 800, the second cover 400, or the third cover 600, the coolant discharge pipe 920 from which a coolant circulating in the second cooling flow channel formed in the battery module cooling unit 800, the second cover 400, or the third cover 600 is discharged, and the coolant dividing unit 940 which is connected to the coolant injection pipe 900 and divides and injects a coolant into the second cooling flow channel formed in the battery module cooling unit 800, the second cover 400, or the third cover 600. In the instant case, the coolant injection pipe 900 and the coolant discharge pipe 920 may be formed outside the first cover 300 and the second cover 400.

Accordingly, according to an exemplary embodiment of the present invention, the second cooling flow channel formed in the battery module cooling unit 800, the second cover 400, or the third cover 600, the battery module cooling unit 800, the coolant injection pipe 900 for injecting a coolant, and the coolant discharge pipe 920 may be formed outside the first cover 300 and the second cover 400, and thus even if a coolant leaks from a connection point between the coolant injection pipe 900 and each cooling flow channel, in which a coolant leaks most frequently, the corresponding coolant may be originally prevented from being scattered to the battery module, enhancing the safety of the battery module.

According to an exemplary embodiment of the present invention, the coolant injection pipe for injecting a coolant into the battery module and the coolant discharge pipe from which a coolant circulating in the cooling unit may be formed outside the battery cover, and thus, even if a coolant leaks, the coolant may be prevented from being scattered to the battery module.

Furthermore, the cooling device configured for cooling the second battery module may be formed above the second battery module and the cooling device configured for cooling the first battery module may be formed below the first battery module, and thus the entire battery module may be uniformly cooled.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A vehicle battery cooling system comprising:
a first battery module;
a second battery module disposed above the first battery module;
a first cover disposed between the first battery module and the second battery module, covering the first battery module, and having the second battery module disposed thereon;
a second cover of covering the second battery module; and
a third cover disposed above the second cover and covering the second cover,
wherein a first cooling flow channel in which a coolant flows, is formed between the second cover and the third cover, and the coolant flows into the first cooling channel path to cool the second battery module.

2. The vehicle battery cooling system of claim 1, wherein the second cover has a side surface portion, an upper surface portion, and an open bottom surface, to form an accommodation space therein for accommodating the second battery module.

3. The vehicle battery cooling system of claim 2, wherein the upper surface portion of the second cover is formed of an aluminum material, the side surface portion is formed of a steel material, and the first cooling flow channel in which the coolant flows is formed in an upper surface of the upper surface portion.

4. The vehicle battery cooling system of claim 2, wherein the second cover further includes an extension portion that extends from an edge portion of the open bottom surface to overlap the first cover.

5. The vehicle battery cooling system of claim 4, wherein the extension portion of the second cover is coupled to an upper portion of the first cover via friction stir welding (FSW) or metal inert gas welding (MIG).

6. The vehicle battery cooling system of claim 1, wherein the first cover includes an open hole formed at a position of the first cover, at which the second battery module is disposed.

7. The vehicle battery cooling system of claim 6, wherein the first cover further includes a sidewall portion that is protrudingly formed along an edge portion of the open hole.

8. The vehicle battery cooling system of claim 7, further including a sealing unit disposed between the sidewall portion and the second cover.

9. The vehicle battery cooling system of claim 7, wherein the sidewall portion, the second cover, the sealing unit, and the third cover are coupled via bolding coupling.

10. The vehicle battery cooling system of claim 1, wherein the second cover is formed in a panel shape and is formed of an aluminum material.

11. The vehicle battery cooling system of claim 9, wherein the first cooling flow channel in which the coolant flows is formed in a bottom surface of the third cover and is formed to cover an upper surface of the second cover.

12. The vehicle battery cooling system of claim 1, further including a battery module cooling unit which is formed below the first battery module, includes a second cooling flow channel in which the coolant flows, and cools the first battery module by allowing the coolant to flow in the second cooling flow channel.

13. The vehicle battery cooling system of claim 12, further including:
a coolant injection pipe which is formed outside the first cover and the second cover and connected to the first cooling flow channel formed between the second cover and the third cover and the second cooling flow channel formed in the battery module cooling unit and is configured to supply the coolant into the first cooling flow channel and the second cooling flow channel; and
a coolant discharge pipe connected to the first cooling flow channel and the second cooling flow channel and from which the coolant circulating in the first cooling flow channel and the second cooling flow channel formed is discharged.

14. The vehicle battery cooling system of claim 13, wherein the coolant injection pipe and the coolant discharge pipe are formed in an external side of each of the first cover and the second cover.

15. The vehicle battery cooling system of claim 13, further including a coolant dividing unit which is connected to the coolant injection pipe and the second cooling flow channel and injects a coolant into the first cooling flow channel and the second cooling flow channel.
